(19) United States
(12) Patent Application Publication
(10) Pub. No.: US 2005/0199354 A1
(43) Pub. Date: Sep. 15, 2005

(54) Device with several points with closue securement, particularly for a sectional closure

(76) Inventors: Alban Nicolas Marandon, Attichy (FR); Philippe Charles Legris, Sailly Fubeaucourt (FR)

Correspondence Address: YOUNG & THOMPSON, 745 SOUTH 23RD STREET, 2ND FLOOR, ARLINGTON, VA, 22202, US

(21) Appl. No.: 10/975,344

(22) Filed: Oct. 29, 2004

(30) Foreign Application Priority Data
Oct. 31, 2003 (FR) 0312787

(51) Int. Cl. E05D 15/00

(52) U.S. Cl. 160/209

(57) ABSTRACT

A device with several points of closure securement, particularly for a sectional closure, of the type comprising a central bolting member (1) for example a lock, and at least one blade (2) for actuating a closure securement block (3). Each actuating blade (2) is in at least two portions (4a, 4b) connected successively by a connecting member (5) with double articulation (6a, 6b), so as to permit the articulation of the sections (A, B) of the closure at least in the open and closed positions of the closure.

The invention relates to a device with several points or securing a closure, particularly for a sectional closure.

The invention is particularly useful for bolting a sectional garage door, a wide doorway flap, or any other sectional closure adapted to be articulated during its opening.

There are known devices with several points as closure securement for metallic constructions. This type of device has a bolting block for each point of closure securement. This bolting block can be inserted and raised into a cutout in the metallic construction by means of a headpiece. The bolting blocks are generally interconnected by at least one actuating blade sliding in the plane of the headpiece. The headpiece can preferably be cut out or recessed to permit the sliding of the actuating blade, whose ends are thus slidably mounted relative to the interior of U shaped configurations provided in the headpiece. This device of known type is satisfactory, but cannot be used for bolting a sectional closure.

The invention has for its object to improve the prior art, by providing a new device usable for the bolting of a sectional closure, both in the open position and in the closed position of the closure.

The invention has for its object a device with several points of closure securement, particularly for sectional closures, of the type comprising a central bolting member, for example a lock, and at least one actuating blade for point of closure securement, characterized by the fact that each actuating blade is discontinuous in at least two portions successively connected by a double articulated connecting member, so as to permit the articulation of the sections of the closure at least in the open end of the closed position of the closure.

According to other alternative characteristics of the invention:
the spacing of the articulations of the double articulation of the connecting member corresponds substantially to the path of the actuating member.
the articulations of the double articulation are preferably substantially coplanar with the articulation of the sections or panels of the closure, when these sections or panels are aligned.
the double articulated connection member can constitute an intermediate connecting rod in the aligned position of the sections or panels of the closure, and an intermediate articulation rod in the articulated position of the sections or panels of the closure.
the double articulated connection member can be configured as a crosspiece with two force transmitting surfaces adapted to coact with the corresponding surfaces of the portions of the actuating blades.
the coincidence of the axis of the hinge for articulating the sections or panels of the closure, and an articulation of the connection member, is preferably obtained in the articulated position of the closure, when these sections or panels are aligned and when the closure is in the bolted or unbolted position.

The invention will be better understood from the following description, given by way of non-limiting example, with reference to the accompanying drawings, in which:

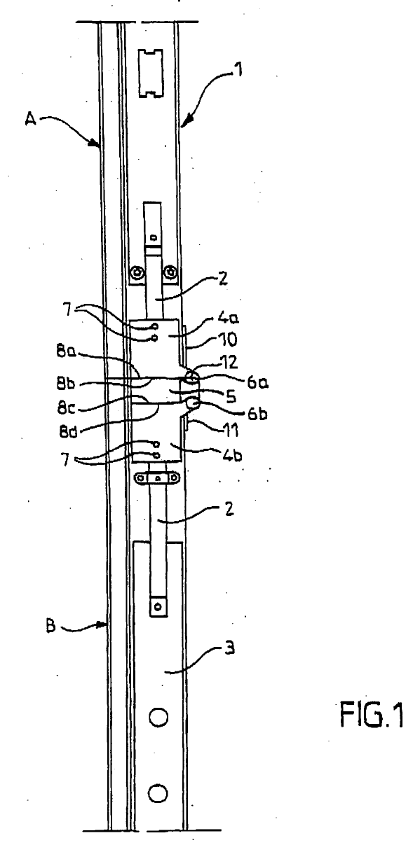

FIG. 1 shows schematically a side view of a closure with aligned panels, provided with a device according to the invention in the bolted position.

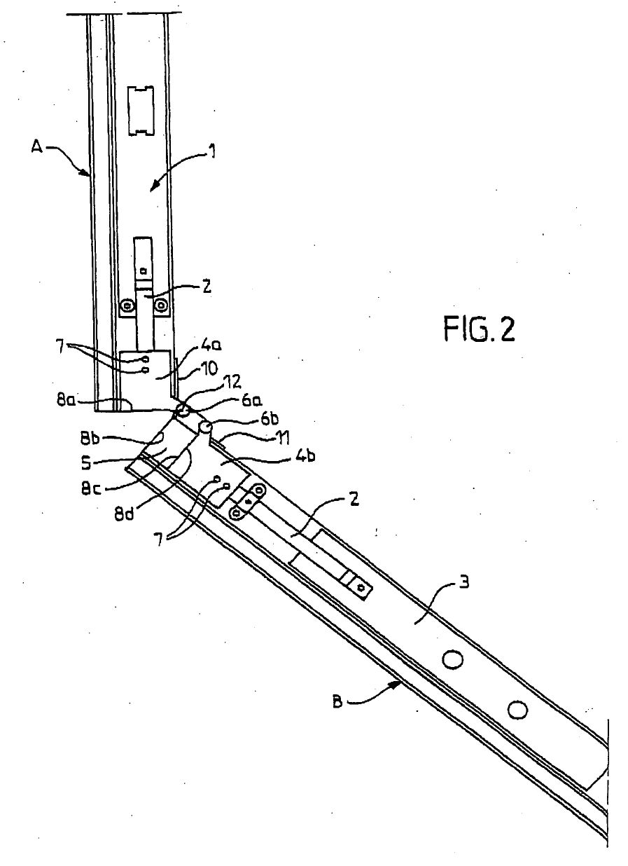

FIG. 2 shows schematically a side view of a closure with articulated panels, provided with a device according to the invention in the bolted position.

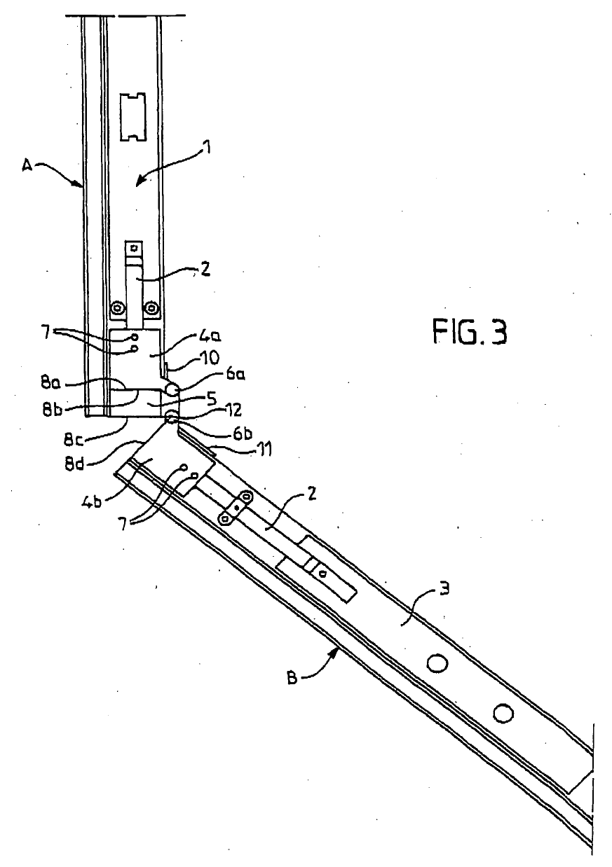

FIG. 3 shows schematically a side view of a closure with articulated panels, provided with a device according to the invention in the unbolted position.

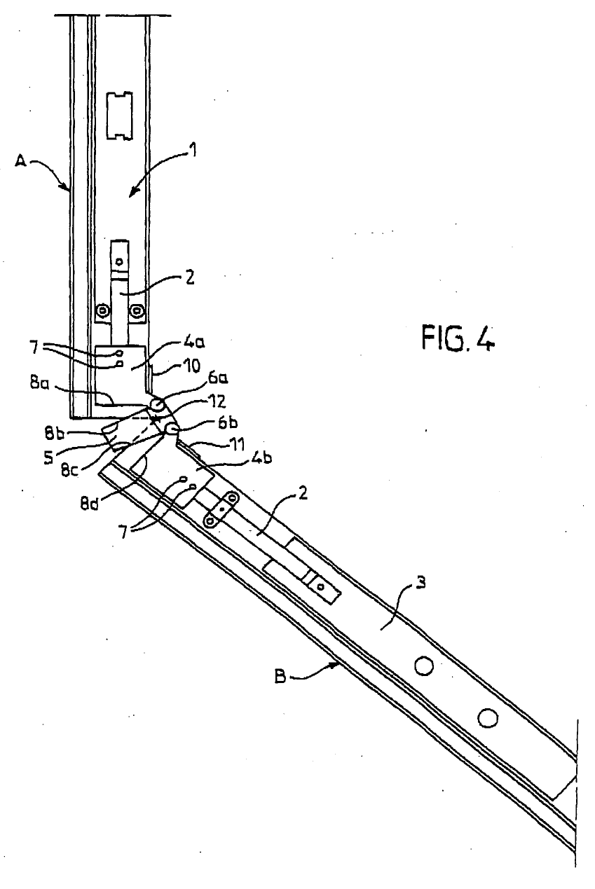

FIG. 4 shows schematically a side view of a closure with articulated panels, provided with a device according to the invention in an intermediate position.

With reference to FIGS. 1 to 4, identical or functional equivalents are given identical reference numerals.

In FIG. 1, a device according to the invention comprises a central bolting member 1, for example a lock, adapted to control the movement of an actuating blade 2 connected to a closure securing lock 3.

The central bolting member 1, in this case a lock, comprises, in a manner known per se, a central housing containing a mechanism and two bolts: a half-turn bolt and a rectangular bolt.

The actuating blade 2 is connected, in a manner known per se, to a reverser or actuator of the central housing, by one or several screws (not shown).

The actuating blade 2 can be held, in a manner known per se, by one or several slides against the edge of one or several panels A, B of the closure or the door.

These panels A, B of the closure or door can be articulated to each other about a geometric axis 12 of articulation, for example by means of a hinge.

The blade 2 is interrupted by a first portion 4a and a second portion 4b, interconnected by a connecting member 5.

The connecting member 5 is a double articulation member: a first articulation 6a with the first portion 4a and a second articulation 6b with the second portion 4b.

The portions 4a and 4b are secured to the ends of the actuating blade 2 permanently, for example by means of rivets 7.

In the position of FIG. 1, the transmission of the bolting force takes place preferably by the bearing against each other of several force transmitting surfaces: a first surface 8a delimiting the portion 4a, a second surface 8b delimiting the upper end of the connecting member 5, a third surface 8c delimiting the lower end of the connecting member 5, and a fourth surface 8b delimiting the portion 4b.

This arrangement has the advantage of causing the connecting member 5 to act in the manner of a crosspiece for transmitting bolting force exerted by the lock 1 on the actuating blade 2.

In FIG. 2, the sectional closure shown in the articulated position has a first section or panel A and a second section or panel B. The relative articulation of the panel sections A, B is achieved with a hinge fixed by tongues 10, 11 respectively to the interior surfaces of the panels A, B.

The geometric axis 12 of the hinge coincides in the position of FIG. 2 with the geometric axis of articulation 6a of the connecting member 5.

This position corresponds to the bolting of the opening in an articulated assembly, because the actuating blade is in its lower position, corresponding to the descent of the articulation 6b along the panel B.

In this position, the surfaces 8a and 8b form an angle between them, whilst the surfaces 8c and 8d remain pressed against each other, even in the articulated position.

To obtain the coincidence of the axis of the hinge of the panels A, B and the axis of articulation 6a, it is advantageous to provide by construction the positioning of the articulations 6a, 6b and the articulation of the hinge in a same plane.

In FIG. 3, a closure comprising the two articulated panels A, B is in the unbolted position, this position corresponding to the coincidence of the axis 12 of the articulation hinge and the articulation 6b of the connecting member 5.

In this position, the articulation 6a is raised to the upper position along the panel A.

The surfaces 8a, 8b remain pressed against each other, whilst the surfaces 8c, 8d form an angle of articulation between themselves.

To obtain simultaneously the coinciding relationships described with reference to FIGS. 2 and 3, it is preferably provided that the spacing of the articulations 6a, 6b corresponds to the path of the actuating blade 2 between its end positions of bolting and unbolting.

In FIG. 4, the articulated closure with its panels A, B is shown in an intermediate position between bolting and unbolting.

In this intermediate position, the axis 12 of the hinge does not coincide either with the axis 6a or with the axis 6b of the connecting member 5.

The surfaces 8a, 8b form between them a first angle of articulation, whilst the surfaces 8c, 8d form between them a second angle of articulation. The sum of the first and second angles of articulation mentioned above is equal to the total angle of relative articulation of the panels A and B.

Because the connecting member 5 is doubly articulated, this double freedom of movement permits the complete release of the member 5 and does not give rise to any parasitic force on the articulations 6a and 6b.

Thus, thanks to the invention, the bolting and unbolting of a closure becomes possible even in the position of articulation; moreover, no parasitic force is transmitted to the mechanism of the device during this bolting and unbolting as shown in FIG. 4.

The invention described with reference to a particular embodiment is in no way limited, but on the contrary covers all modifications of shape and any modification of embodiment of the invention, the essential fact being that a double articulation connection permits simultaneously the articulation of the sections of the closure as well as its bolting and unbolting.

The three successive elements: portions 4a, 4b and member 5 are thus articulated thanks to the invention so as to follow the movement of the panels A, B, during opening and closing of a closure or a sectional door.

The articulation of the three successive elements: portion 4a, 4b and member 5, as well as the opening and closing of a closure or a sectional door, are carried out in the bolted and unbolted position, thanks to the invention.

The articulation of the three successive elements: portions 4a, 4b and member 5, permits the transmission of an axial force and permits the rotation of the panels A, B about their axis 12 of articulation.

When the closure or sectional door is closed, the three successive elements: portions 4a, 4b and member 5 are aligned. The three successive elements: portions 4a, 4b and member 5 thus coact by permitting the transmission of an axial force, which permits their movement and effectuates the bolting or unbolting of the device according to the invention.

During opening of the closure or sectional door, the panels A, B pivot about their geometric axis 12. The three successive elements: portions 4a, 4b and member 5 pivot about the axis 6a when the closure or sectional door is bolted, or about the axis 6b when the closure or sectional door is unbolted, thanks to the invention.

In these two cases, the pivoting and the raising of a sectional garage door, or a wide flap door, is possible.

In the case of an intermediate position, the axis of rotation of the panels A, B is located between the axes 6a and 6b. The articulation of the three successive elements: portions 4a, 4b and member 5 remains equally possible thanks to the invention, by means of the combined partial rotations about the axes 6a and 6b.

1. Device for several bolting points, particularly for a sectional door, of the type comprising a central bolting member (1), for example a lock, and at least one blade (2) for actuating a point (3) of closure securement, characterized by the fact that each actuating blade (2) is divided into at least two portions (4a, 4b) connected successively by a connecting member (5) with double articulation (6a, 6b), so as to permit the articulation of sections (A, B) of the closure at least in the open and closed position of the closure.

2. Device according to claim 1, characterized by the fact that the spacing of the articulations (6a, 6b) of the double articulation of the connecting member (5) corresponds substantially to the length of the path of the actuating member (5).

3. Device according to claim 1, characterized by the fact that the articulations (6a, 6b) of the double articulation of the connecting member (5) are substantially coplanar with the articulation (12) of the sections or panels (A, B) of the closure, when these sections or panels (A, B) are aligned.

4. Device according to claim 1, characterized by the fact that the double articulation connector member (5) constitutes an intermediate connecting rod in the aligned position of the sections or panels (A, B) of the closure, and an intermediate articulation rod in the articulated position of the sections or panels (A, B) of the closure.

5. Device according to claim 1, characterized by the fact that the connecting member (5) with double articulation (6a, 6b) is in the form of a crosspiece with two surfaces (8b, 8c) for the transmission of force adapted to coact with corresponding surfaces (a, 8d) of the portions (4a, 4b) of the actuating blade (2).

6. Device according to claim 1, characterized by the fact that the coincidence of the axis (12) of the articulation hinge for the sections or panels (A, B) of the closure and of an articulation (6a or 6b) of the connecting member (5) is obtained in the articulation position of the closure, when these sections or panels (A, B) are aligned and when the closure is in the bolted or unbolted position.
